(19) United States
(12) Patent Application Publication
(10) Pub. No.: US 2024/0330115 A1
(43) Pub. Date: Oct. 3, 2024

(54) MANAGEMENT AND CONTROL FOR EPHEMERAL DATA

(71) Applicant: Micron Technology, Inc., Boise, ID (US)

(72) Inventor: David Andrew Roberts, Wellesley, MA (US)

(21) Appl. No.: 18/600,256

(22) Filed: Mar. 8, 2024

Related U.S. Application Data
(60) Provisional application No. 63/455,188, filed on Mar. 28, 2023.

(51) Int. Cl. G06F 11/14; G06F 11/07

(52) U.S. Cl. CPC G06F 11/1451; G06F 11/076; G06F 11/0772; G06F 11/1458

(57) ABSTRACT

Methods, systems, and devices for management and control for ephemeral data are described. A host system may configure a memory device of a memory system to store ephemeral data. The host system may configure the memory device for a performance mode, which may include suspending memory management operations of a portion of the memory device based on allocating the portion for storing the ephemeral data. After storing the ephemeral data to the portion, the memory system may perform an error control procedure to identify one or more errors in the ephemeral data. The memory system may transmit an indication of the one or more errors to the host system, where the host system may determine to ignore the errors, or transfer back-up ephemeral data to the portion of the memory device from another portion of the memory device or from another memory device of the memory system.

### CROSS REFERENCE

The present Application for Patent claims priority to and the benefit of U.S. Provisional Application No. 63/455,188 by Roberts et al., entitled “MANAGEMENT AND CONTROL FOR EPHEMERAL DATA,” filed Mar. 28, 2023, assigned to the assignee hereof, and is expressly incorporated by reference in its entirety herein.

### TECHNICAL FIELD

The following relates to one or more systems for memory, including management and control for ephemeral data.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports management and control for ephemeral data in accordance with examples as disclosed herein.

FIG. 2 shows an example of a system that supports management and control for ephemeral data in accordance with examples as disclosed herein.

FIG. 3 shows an example of a process flow that supports management and control for ephemeral data in accordance with examples as disclosed herein.

FIG. 4 shows a block diagram of a memory system that supports management and control for ephemeral data in accordance with examples as disclosed herein.

FIG. 5 shows a block diagram of a host system that supports management and control for ephemeral data in accordance with examples as disclosed herein.

FIGS. 6 and 7 show flowcharts illustrating a method or methods that support management and control for ephemeral data in accordance with examples as disclosed herein.

### DETAILED DESCRIPTION

In some cases, there may be a desire to operate a memory system such that a performance of a portion of the memory system is prioritized over a reliability of data stored by the memory system. For example, in some applications, there may be a desire to operate the memory system with a relatively low latency, such that data stored in the memory system may be accessed relatively quickly. However, in some such cases, prioritizing the performance of the memory system may adversely affect data retention or data reliability of the memory system such that ensuring relatively high performance may be associated with decreased retention or reliability for the data stored in the memory system. For example, prioritizing the performance of the memory system may include decreasing a refresh rate of the data or error control capabilities of the memory system.

In accordance with examples as described herein, a memory device of a memory system may be configured to store ephemeral data (e.g., temporary data), which may be associated with a relatively low priority for data retention, thereby enabling the memory device to be configured to offer greater speed for accessing the memory device. The ephemeral data may be associated with a relatively lower retention duration than other data stored at the memory system, therefore storing the ephemeral data in the memory device may enable the memory system to prioritize performance (e.g., speed of access) at the memory device rather than prioritizing data retention at a memory device. For example, prioritizing the performance of the memory device may include decreasing a refresh rate of the ephemeral data or error control capabilities of the memory device, which may enable relatively higher latency for accessing the ephemeral data. Thus, implementing the memory device at the memory system may enable the memory system to prioritize performance without adversely affecting the other data stored at the memory system.

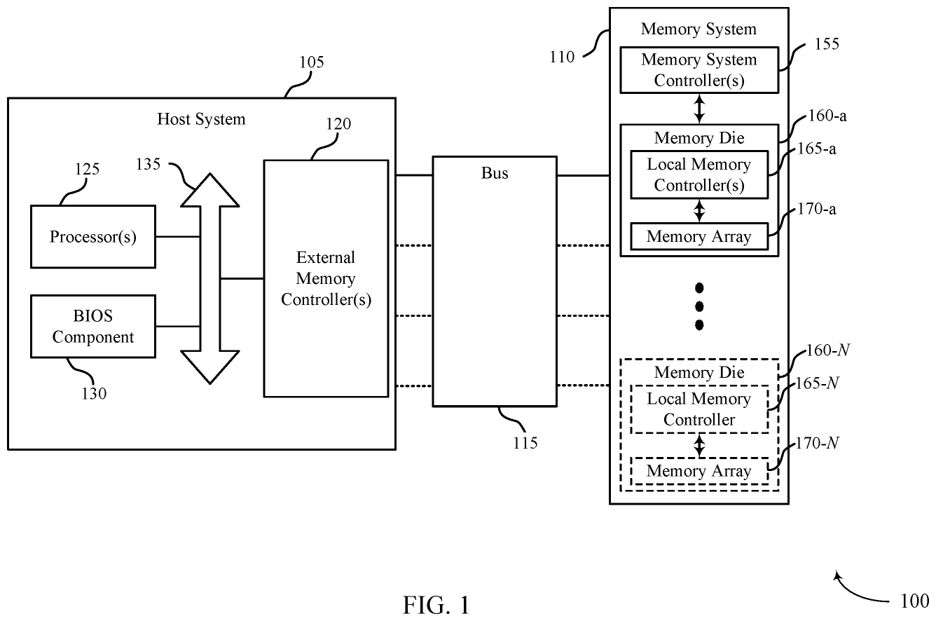

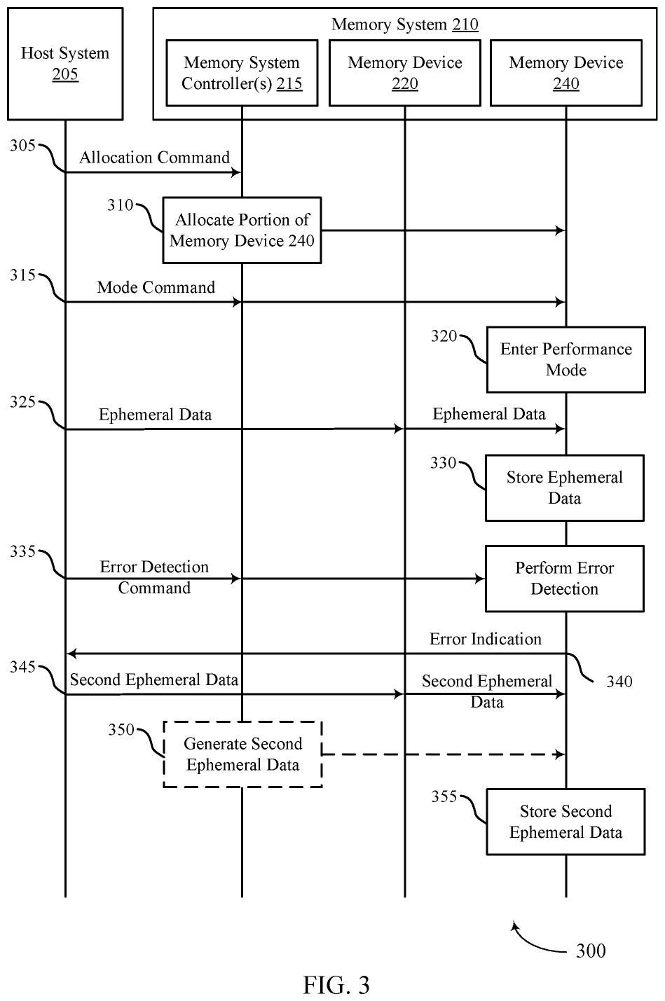

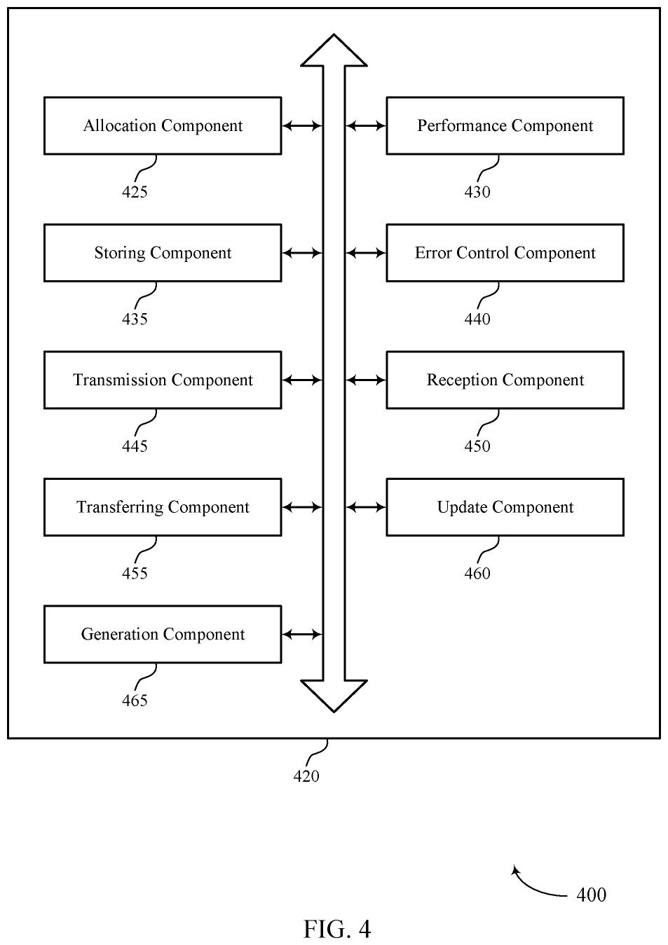

Features of the disclosure are initially described in the context of systems and a process flow as described with reference to FIGS. 1 and 3. These and other features of the disclosure are further illustrated by and described with reference to an apparatus diagram and flowcharts that relate to management and control for ephemeral data as described with reference to FIGS. 4 through 7.

FIG. 1 shows an example of a system 100 that supports management and control for ephemeral data in accordance with examples as disclosed herein. The system 100 may include a host system 105, a memory system 110, and a bus 115 coupling the host system 105 with the memory system 110. The system 100 may include one or more memory systems 110, but aspects of the one or more memory systems 110 may be described in the context of a single memory system (e.g., memory system 110).

The system 100 may include portions of an electronic device, such as a computing device, a mobile computing device, a wireless device, a graphics processing device, a vehicle, or other systems. For example, the system 100 may illustrate aspects of a computer, a laptop computer, a tablet computer, a smartphone, a cellular phone, a wearable device, an internet-connected device, a vehicle controller, or the like. The memory system 110 may be a component of the system 100 that is operable to store data for one or more other components of the system 100.

Portions of the system 100 may be examples of the host system 105. The host system 105 may be an example of a processor (e.g., circuitry, processing circuitry, a processing component) within a device that uses memory to execute processes, such as within a computing device, a mobile computing device, a wireless device, a graphics processing device, a computer, a laptop computer, a tablet computer, a smartphone, a cellular phone, a wearable device, an internet-connected device, a vehicle controller, a system on a chip (SoC), or some other stationary or portable electronic device, among other examples. In some examples, the host system 105 may refer to the hardware, firmware, software, or any combination thereof that implements the functions of an external memory controller 120. In some examples, the external memory controller 120 may be referred to as a host (e.g., host system 105).

A memory system 110 may be an independent device or a component that is operable to provide physical memory addresses/space that may be used or referenced by the system 100. In some examples, a memory system 110 may be configurable to work with one or more different types of host devices. Signaling between the host system 105 and the memory system 110 may be operable to support one or more of: modulation schemes to modulate the signals, various pin configurations for communicating the signals, various form factors for physical packaging of the host system 105 and the memory system 110, clock signaling and synchronization between the host system 105 and the memory system 110, timing conventions, or other functions.

The memory system 110 may be operable to store data for the components of the host system 105. In some examples, the memory system 110 (e.g., operating as a secondary-type device to the host system 105, operating as a dependent-type device to the host system 105) may respond to and execute commands provided by the host system 105 through the external memory controller 120. Such commands may include one or more of a write command for a write operation, a read command for a read operation, a refresh command for a refresh operation, or other commands.

The host system 105 may include one or more of one or more external memory controllers 120, one or more processors 125, a basic input/output system (BIOS) component 130, or other components such as one or more peripheral components or one or more input/output controllers. The components of the host system 105 may be coupled with one another using a bus 135.

The processor 125 may be operable to provide functionality (e.g., control functionality) for the system 100 or the host system 105. The processor 125 may be a general-purpose processor, a digital signal processor (DSP), an application-specific integrated circuit (ASIC), a field-programmable gate array (FPGA) or other programmable logic device, discrete gate or transistor logic, discrete hardware components, or any combination of these components. In such examples, the processor 125 may be an example of a central processing unit (CPU), a graphics processing unit (GPU), a general purpose GPU (GPGPU), or an SoC, among other examples. In some examples, the external memory controller 120 may be implemented by or be a part of the processor 125.

The BIOS component 130 may be a software component that includes a BIOS operated as firmware, which may initialize and run various hardware components of the system 100 or the host system 105. The BIOS component 130 may also manage data flow between the processor 125 and the various components of the system 100 or the host system 105. The BIOS component 130 may include instructions (e.g., a program, software) stored in one or more of read-only memory (ROM), flash memory, or other non-volatile memory.

In some examples, the system 100 or the host system 105 may include an input component, an output component, or both. An input component may represent a device or signal external to the system 100 that provides information (e.g., signals, data) to the system 100 or its components. In some examples, and input component may include an interface (e.g., a user interface or an interface between other devices). In some examples, an input component may be a peripheral that interfaces with system 100 via one or more peripheral components or may be managed by an I/O controller. An output component may represent a device or signal external to the system 100 operable to receive an output from the system 100 or any of its components. Examples of an output component may include a display, audio speakers, a printing device, another processor on a printed circuit board, and others. In some examples, an output may be a peripheral that interfaces with the system 100 via one or more peripheral components or may be managed by an I/O controller.

The memory system 110 may include one or more memory system controllers 155 and one or more memory dies 160 (e.g., memory chips) to support a capacity (e.g., a desired capacity, a specified capacity) for data storage. Each memory die 160 (e.g., memory die 160-a, memory die 160-N) may include one or more local memory controllers 165 (e.g., local memory controller 165-a, local memory controller 165-N) and one or more memory arrays 170 (e.g., memory array 170-a, memory array 170-N). A memory array 170 may be a collection (e.g., one or more grids, one or more banks, one or more tiles, one or more sections) of memory cells, with each memory cell being operable to store one or more bits of data. A memory system 110 including two or more memory dies 160 may be referred to as a multi-die memory or a multi-die package or a multi-chip memory or a multi-chip package.

The memory system controller 155 may include components (e.g., circuitry, logic) operable to control operation of the memory system 110. The memory system controller 155 may include hardware, firmware, or instructions that enable the memory system 110 to perform various operations and may be operable to receive, transmit, or execute commands, data, or control information related to the components of the memory system 110. The memory system controller 155 may be operable to communicate with one or more of the external memory controller 120, the one or more memory dies 160, or the processor 125. In some examples, the memory system controller 155 may control operation of the memory system 110 described herein in conjunction with the local memory controller 165 of the memory die 160.

In some examples, the memory system 110 may communicate information (e.g., data, commands, or both) with the host system 105. For example, the memory system 110 may receive a write command indicating that the memory system 110 is to store data received from the host system 105, or receive a read command indicating that the memory system 110 is to provide data stored in a memory die 160 to the host system 105, among other types of information communication.

A local memory controller 165 (e.g., local to a memory die 160) may include components (e.g., circuitry, logic) operable to control operation of the memory die 160. In some examples, a local memory controller 165 may be operable to communicate (e.g., receive or transmit data or commands or both) with the memory system controller 155. In some examples, a memory system 110 may not include a memory system controller 155, and a local memory controller 165 or the external memory controller 120 may perform various functions described herein. As such, a local memory controller 165 may be operable to communicate with the memory system controller 155, with other local memory controllers 165, or directly with the external memory controller 120, or the processor 125, or any combination thereof. Examples of components that may be included in the memory system controller 155 or the local memory controllers 165 or both may include receivers for receiving signals (e.g., from the external memory controller 120), transmitters for transmitting signals (e.g., to the external memory controller 120), decoders for decoding or demodulating received signals, encoders for encoding or modulating signals to be transmitted, or various other components operable for supporting described operations of the memory system controller 155 or local memory controller 165 or both.

The external memory controller 120 may be operable to enable communication of information (e.g., data, commands, or both) between components of the system 100 (e.g., between components of the host system 105, such as the processor 125, and the memory system 110). The external memory controller 120 may process (e.g., convert, translate) communications exchanged between the components of the host system 105 and the memory system 110. In some examples, the external memory controller 120, or other component of the system 100 or the host system 105, or its functions described herein, may be implemented by the processor 125. For example, the external memory controller 120 may be hardware, firmware, or software, or some combination thereof implemented by the processor 125 or other component of the system 100 or the host system 105. Although the external memory controller 120 is depicted as being external to the memory system 110, in some examples, the external memory controller 120, or its functions described herein, may be implemented by one or more components of a memory system 110 (e.g., a memory system controller 155, a local memory controller 165) or vice versa.

The components of the host system 105 may exchange information with the memory system 110 using one or more directional differential signals of the bus 115. The bus 115 may be operable to support communications between the external memory controller 120 and the memory system 110. Each bus 115 may be an example of a transmission medium that carries information between the host system 105 and the memory system 110. Each bus 115 may include one or more signal paths (e.g., a transmission medium, a conductor) between terminals associated with the components of the system 100. A signal path may be an example of a conductive path operable to carry a signal. For example, a bus 115 may be associated with a first terminal (e.g., including one or more pins, including one or more pads) at the host system 105 and a second terminal at the memory system 110. A terminal may be an example of a conductive input or output point of a device of the system 100, and a terminal may be operable to act as part of a bus.

The bus 115 (and associated signal paths and terminals) may be dedicated to communicating one or more types of information. In some cases, the bus 115 may be an example of serial buses such as a CXL or a PCIe. For example, signaling may be communicated over the bus 115 using single data rate (SDR) signaling or double data rate (DDR) signaling. In SDR signaling, one modulation symbol (e.g., signal level) of a signal may be registered for each clock cycle (e.g., on a rising or falling edge of a clock signal). In DDR signaling, two modulation symbols (e.g., signal levels) of a signal may be registered for each clock cycle (e.g., on both a rising edge and a falling edge of a clock signal).

In some examples, the bus 115 may be operable to communicate commands, addresses, data, other information, or any combination thereof between the host system 105 and the memory system 110. For example, commands carried by the bus 115 may include a read command with an address of the desired data. In some examples, the bus 115 may include any quantity of signal paths (e.g., eight or nine signal paths) to communicate control information (e.g., commands or addresses). In some cases, the bus 115 may communicate information between the host system 105 and the memory system 110 via packets. In some cases, commands transferred between the host system 105 and the memory system 110 (e.g., implementing CXL, Gen-Z, or other advanced interconnection schemes) may include cache coherence transactions, read or write to performance counters, or vender-specific custom commands transferred as packets.

In some examples, the bus 115 may be operable to communicate one or more clock signals between the host system 105 and the memory system 110. Clock signals may be operable to oscillate between a high state and a low state, and may support coordination (e.g., in time) between actions of the host system 105 and the memory system 110. In some examples, the clock signal may be single ended. In some examples, the clock signal may provide a timing reference for command and addressing operations for the memory system 110, or other system-wide operations for the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

In accordance with examples as described herein, a memory die 160 of the memory system 110 may be configured to store ephemeral data (e.g., temporary data), which may be associated with a relatively low priority for data retention, thereby enabling the memory die 160 to offer greater performance. The ephemeral data may be associated with a relatively lower retention duration than other data stored at the memory system 110, therefore storing the ephemeral data in the memory die 160 may enable the memory system 110 to prioritize performance at the memory die 160 rather than prioritizing performance at another memory die 160 storing data associated with a relatively higher priority for data retention. For example, prioritizing the performance of the memory die 160 may include decreasing a refresh rate of the ephemeral data or error control capabilities of the memory die 160, which may enable relatively higher latency for accessing the ephemeral data, thereby increasing a performance of the memory die 160. Thus, implementing the memory die 160 at the memory system 110 may enable the memory system 110 to prioritize performance without adversely affecting the other data stored at the memory system 110.

In addition to applicability in memory systems as described herein, techniques for management and control of ephemeral data may be generally implemented to support artificial intelligence applications. As the use of artificial intelligence increases to support machine learning, analytics, decision making, or other related applications, electronic devices that support artificial intelligence applications and processes may be desired. For example, artificial intelligence applications may be associated with accessing relatively large quantities of data for analytical purposes and may benefit from memory devices capable of effectively and efficiently storing relatively large quantities of data or accessing stored data relatively quickly. Implementing the techniques described herein may support artificial intelligence and/or machine learning techniques by enabling a memory system to be switched between a high performance, low retention mode and a low performance, high retention mode thereby supporting selectively improving memory access speeds, among other benefits. For example, deep neural networks associated with a tolerance for detected errors may be implemented at a memory system to decrease error control operations at the memory system.

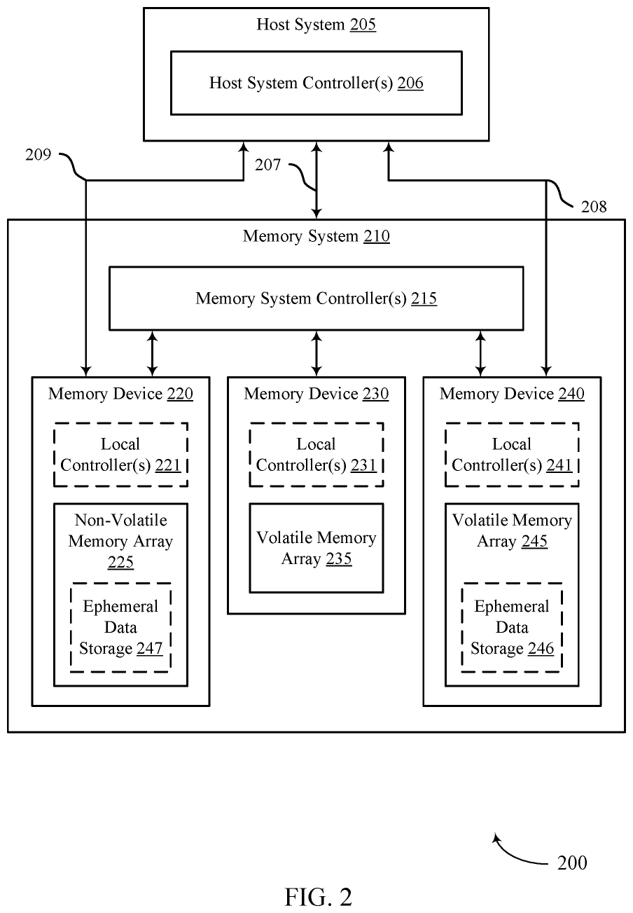

FIG. 2 shows an example of a system 200 that supports management and control for ephemeral data in accordance with examples as disclosed herein. The system 200 may be an example of and implement aspects of a system 100, as described with reference to FIG. 1. For example, the system 200 may include a host system 205 and a memory system 210, which may be examples of a host system 105 and a memory system 110, respectively, as described with reference to FIG. 1. The memory system 210 may implement a memory device 240 configured to store ephemeral data to improve an access latency of the memory device 240, thereby improving a performance of the memory system 210.

The host system 205 may be coupled with the memory system 210 and may be configured to communicate with the memory system 210. The host system 205 may include one or more host system controllers 206, which may be an example of an external memory controller 120, as described with reference to FIG. 1. The host system controller 206 may facilitate operations of the host system 205 or the memory system 210, or both, and facilitate communication between the host system 205 and the memory system 210 via a bus 207. For example, the host system controller 206 may perform operations (e.g., access operations) on the memory system 210 or configure the memory system 210 for performing operations in accordance with commands transmitted from the host system 205 (e.g., the host system controller 206). The host system controller 206 may support a DRAM memory architecture and a NAND memory architecture, among other memory architectures (e.g., FeRAM memory, SRAM memory) implemented at the host system 205 or the memory system 210.

The memory system 210 may include one or more memory system controllers 215, which may be an example of a memory system controller 155, as described with reference to FIG. 1. The memory system controller 215 may also facilitate operations of the memory system 210 and perform operations on the memory system 210 in accordance with commands received from the host system 205 (e.g., the host system controller 206). In some cases, the memory system controller 215 may be an example of a CXL controller, which may include a physical layer interface, a CXL interface, a central controller, or a memory controller array, among other constituent components or combinations thereof. Each of the components of the memory system controller 215 may refer to a portion of hardware, firmware, software (e.g., stored in a non-transitory computer readable medium of the memory system controller 215), or any combination thereof that is configured to support a functionality of the memory system controller 215.

The memory system 210 may include a memory device 220, a memory device 230, and a memory device 240, which may be examples of a memory die 160, as described with reference to FIG. 1. The memory device 220 may include a non-volatile memory array 225 (e.g., a NAND memory array), which may include non-volatile memory cells. However, in some examples, the memory device 220 may be configured to include a volatile memory array which may include volatile memory cells. In some cases, the memory device 220 may include one or more local controllers 221 configured to perform operations on the non-volatile memory array 225 in accordance with communication (e.g., commands) from the memory system controller(s) 215 or the host system controller(s) 206. In other cases, the memory device 220 may be coupled directly with the host system 205 (e.g., the host system controller 206) via a bus 209, such that the host system controller 306 may facilitate operations or configurations of the memory device 220. The memory device 230 may include a volatile memory array 235 (e.g., a DRAM memory array), which may include volatile memory cells. In some cases, the memory device 230 may include a local controller 231 configured to perform operations on the volatile memory array 235 in accordance with communication (e.g., commands) from the memory system controller(s) 215 or the host system controller(s) 206. The memory device 240 may include a volatile memory array 245 (e.g., a DRAM memory array) which may include volatile memory cells. However, in some examples, the memory device 240 may be configured to include a non-volatile memory array which may include non-volatile memory cells. In some cases, the memory device 240 may include a local controller 241 configured to perform operations on the volatile memory array 245 in accordance with communication (e.g., commands) from the memory system controller(s) 215 or the host system controller(s) 206. In other cases, the memory device 240 may be coupled directly with the host system 205 (e.g., the host system controller 206) via a bus 208, such that the host system controller 306 may facilitate operations or configurations of the memory device 240.

The memory device 220 or the memory device 240 may be configured to store ephemeral data in an ephemeral data storage 247 or an ephemeral data storage 246, respectively, which may be a portion of the respective memory array configured for storing ephemeral data. For example, a portion of the volatile memory array 245 may be configured to function as the ephemeral data storage 246, or a portion of the non-volatile memory array 225 may be configured to function as the ephemeral data storage 247, or both. In some cases, the ephemeral data storage 247 and the ephemeral data storage 246 may function similarly to a read only memory cache but may be host managed (e.g., rather than managed by the memory system 210). For example, the ephemeral data storage 247 and the ephemeral data storage 246 may implement cache processes such as write through processes, in which a back-up version of the ephemeral data may be written to a back-up location concurrently with storing the ephemeral data to the ephemeral data storage 247 or the ephemeral data storage 246. The ephemeral data may be associated with a relatively low priority for data retention such that a data retention duration of the ephemeral data may be relatively lower than a data retention duration for other data stored in the memory system 210. For example, the ephemeral data may be expected to be accessed within a threshold duration, such that the ephemeral data may not be actively maintained (e.g., refreshed, error corrected) prior to satisfying the threshold duration. Ephemeral data may refer to data that has a relatively shorter duration (e.g., hours) than other data stored in a memory device (e.g., days, months, years). For example, if a memory device is a DRAM memory device, data may be configured to be retained and be relatively-free from errors for a certain duration of time. Ephemeral data stored in a DRAM device may be data that that has a shorter duration than other data and thus some data retention procedures and error control procedures may be relaxed or eliminated for the ephemeral data. In another example, if a memory device is a NAND memory device, the data retention duration for ephemeral data in a NAND memory device may be different than the data retention duration for the ephemeral data in a DRAM memory device.

In some cases, the ephemeral data may be data associated with a high likelihood of errors detected during read operations (e.g., rather than write operations). In some such cases, the ephemeral data may be data with a high read priority or read data that may not be frequently modified. For example, the ephemeral data may be an example of data associated with search tables (e.g., look-up tables) involved in mathematical operations. In another example, the ephemeral data may be an example of neural network weights for inference and object detection in AI applications.

In some cases, the memory system controller(s) 215 or the host system controller(s) 206 may configure the memory device 220 or the memory device 240 to improve a performance of the memory device 220 or the memory device 240, respectively. For example, the memory system 210 may be set to a performance mode (e.g., in response from a command from the host system 205), and the memory device 240 or the memory device 220 may be configured (e.g., by the host system controller 206) to support the performance mode. In some cases, supporting the performance mode at the memory device 240 may include allocating the ephemeral data storage 246 from a portion of the volatile memory array 245, storing ephemeral data to the ephemeral data storage 246, and suspending memory management operations for the ephemeral data (e.g., the ephemeral data storage 246). In some such cases, a similar process may be implemented to support the performance mode at the memory device 220. In some examples, the process may be implemented at the memory device 220 or the memory device 240, or both concurrently. Suspending the memory management operations may include refraining from performing refresh operations on the ephemeral data, decreasing a frequency for performing error detection on the ephemeral data, and refraining from performing error correction operations (e.g., memory scrubbing) on the ephemeral data. In some such examples, the frequency for performing the error detection on the ephemeral data may be decreased such that performing the error detection includes performing a periodic error check (e.g., based on a frequency indicated from the host system controller 206) to determine a quantity of errors in the data, without correcting the errors in the data. In some cases, suspending the memory management operations may decrease a latency associated with accessing the respective memory device, thereby decreasing latency for performing access operations on the memory system 210 and improving a performance of the memory system 210. Additionally, suspending the memory management operations may conserve bandwidth of the memory system controller(s) 215 or the host system controller(s) 206, otherwise dedicated to performing the memory management operations.

In some cases, in response to detecting one or more errors during performing the periodic error check, an indication may be transmitted (e.g., from the memory system controller(s) 215) to the host system 205 (e.g., the host system controller(s) 206). In some examples, the memory system controller(s) 215 may transmit a system interrupt to the host system controller 206 indicating one or more addresses of the respective memory array (that stores ephemeral data) are associated with the one or more errors. In some implementations, the host system controller 206 may utilize the indication, or query the respective memory device to determine the one or more addresses and suspend processes associated with the one or more addresses. In other examples, the memory system controller(s) 215 may transmit a message (e.g., indicating one or more errors) to a queue between the memory system 210 and the host system 205, and the host system controller 206 may check the queue periodically to determine whether one or more errors are present in the respective memory device. In some cases, that may be an example of a queuing message system.

In other examples, ephemeral data may be stored using a dedicated operating code. In such examples, a host system 205 may send an ephemeral data write command (e.g., using the dedicated operation code) along with ephemeral data associated with write commands. The memory system 210 may then store the ephemeral data. In response to using the dedicated operation code, the memory system 210 may perform the periodic error check on the ephemeral data. If the dedicated operating code (e.g., an ephemeral load code, ephemeral data write command) was used, the respective memory device (e.g., the memory device 220, the memory device 240) may continue normal operations rather than suspending normal operations to correct the one or more errors. In some such examples, after detecting the one or more errors, the dedicated operating code may dictate the respective memory device to perform corrective processes for the one or more errors in the background operation of the respective memory device (e.g., with a low priority for error correction). The memory system 210 may determine whether a dedicated operating code was used based on metadata associated with the data or based on the portion of the respective memory device that the data is stored.

In other examples, in response to detecting one or more errors, one or more values (e.g., corresponding to one or more addresses) of a register associated with the respective memory device (e.g., the memory device 220, the memory device 240) may be updated to reflect the one or more errors. Such techniques may be an example of using a condition code register (CCR) to indicate whether ephemeral data includes one or more errors. In some such examples, the host system controller 206 may check the register to determine if one or more values of the register indicate the one or more errors. In some cases, in response to detecting a quantity of errors (e.g., by the period error check) the memory system controller(s) 215 or the host system controller(s) 206 may determine not to correct the quantity of errors. For example, the quantity of errors may be less than a threshold quantity of errors, and the errors may be ignored due to an allowance quantity of errors in the ephemeral data (e.g., based on deep neural networks). In some such examples, the ephemeral data may be an example of error resistant data, such that the ephemeral data may have a quantity of allowable errors in the data. For example, the ephemeral data may be neural network weights that may be associated with performing operations for facilitating machine learning. In some such examples, the neural network weights may have a quantity of allowable errors present in the neural network weights, such that the neural network weights may perform the operations for facilitating the machine learning as long as the quantity of errors is less than (e.g., or equal to) the quantity of allowable errors.

In some cases, in response to detecting the one or more errors during performing the periodic error check and transmitting the indication to the host system 205, additional ephemeral data may be stored to the ephemeral data storage 246 or the ephemeral data storage 247. For example, in response to the indication, second ephemeral data associated with a back-up of the ephemeral data (e.g., stored in the ephemeral data storage 246) may be stored to the ephemeral data storage 246. In some examples, storing the second ephemeral data to the ephemeral data storage 246 may include transferring the second ephemeral data from another portion of the memory device 240 or from another memory device (e.g., the memory device 220 or the memory device 230). For example, the memory device 220 may include the second ephemeral data in the non-volatile memory array 225, and the memory system controller(s) 215 or the host system controller(s) 206 may facilitate transferring the second ephemeral data to the ephemeral data storage 246. In some implementations, the second ephemeral data may be stored to the other portion of the memory device 240 or the other memory device when the ephemeral data is stored to the ephemeral data storage 246, such that the ephemeral data and the second ephemeral data may be written concurrently.

In other examples, storing the second ephemeral data to the ephemeral data storage 246 may include generating the second ephemeral data based on recomputing the ephemeral data at the local controller 241, the memory system controller(s) 215, or the host system controller(s) 206. In some implementations, storing the second ephemeral data to the ephemeral data storage 246 may include replacing (e.g., erasing) the ephemeral data. In some implementations, the second ephemeral data may be generated prior to detecting the one or more errors such that the second ephemeral data may be generated concurrently with generating the ephemeral data.

In accordance with examples as described herein, implementing the memory device 220 or the memory device 240, or both configured with the ephemeral data storage 246 or the ephemeral data storage 247 may support decreased latency and increased bandwidth for operating the memory system 210. For example, suspending the memory management operations may decrease the latency and bandwidth for operating the respective memory device. In some implementations, suspending the memory management operations on data may also decrease a reliability of the data, however because the ephemeral data is already associated with a low data retention priority, the memory management operations may be suspended without adversely affecting the reliability of the data. Therefore, the memory system 210 latency may be improved by improving the performance of the respective memory device. Accordingly, the memory system 210 may not risk the reliability of data associated with a high data retention priority (e.g., stored in the non-volatile memory array 225 or the volatile memory array 235), by suspending the memory management operations at the corresponding memory devices (e.g., the memory device 220, the memory device 230, the memory device 240, not implementing the ephemeral data storage).

FIG. 3 shows an example of a process flow 300 that supports management and control for ephemeral data in accordance with examples as disclosed herein. The process flow 300 may illustrate aspects or operations of a system 200, such as a host system 205 and a memory system 210, which includes one or more memory system controllers 215, a memory device 220, and a memory device 240, as described with reference to FIG. 2. In some cases, operations involving the memory device 220 may be similarly performed for a memory device 230, such that the operations involving the memory device 220 may support a NAND memory architecture or a DRAM memory architecture, among other memory architectures (e.g., FeRAM memory, SRAM memory). In some such cases, the memory device 220 may be replaced by the memory device 230 in the process flow 300. In some cases, operations involving the memory device 240 may be similarly performed for a memory device 220, such that the operations involving the memory device 240 may support a DRAM memory architecture or a NAND memory architecture, among other memory architectures (e.g., FeRAM memory, SRAM memory). In some such cases, the memory device 240 may be replaced by the memory device 220 in the process flow 300. In some cases, the host system 205 may include a host system controller 206, which may facilitate operations of the host system 205, as described with reference to FIG. 2. In the following description of the process flow 300, the methods, techniques, processes, and operations may be performed in different orders or at different times. Further, certain operations may be left out of the process flow 300, or other operations may be added to the process flow 300. The process flow 300 may depict operations associated with operating the memory device 240 in a performance mode to reduce latency and bandwidth consumption at the memory system 210.

At 305, the host system 205 may transmit a command to the memory system controller 215 indicating the memory system controller 215 to allocate a portion of the memory device 240 (e.g., a portion of a volatile memory array 245) for storing ephemeral data (e.g., ephemeral data storage 246). In some cases, the command may indicate to allocate a portion of the memory device 220 (e.g., a portion of the non-volatile memory array 225) for storing ephemeral data (e.g., ephemeral data storage 247). In some cases, the host system 205 may transmit the command based on an initialization procedure of the system 200. In other cases, the host system 205 may transmit the command based on a desire for the memory system 210 to enter a relatively higher performance state. For examples involving AI applications, the host system 205 may dynamically determine a desire for lower latency or reduced bandwidth consumption associated with accessing the memory system 210, and the host system 205 may transmit the command based on the dynamically determined desired latency.

In some cases, the command may indicate a size (e.g., a quantity of bytes) of the portion of the memory device 240 (e.g., or the memory device 220) to allocate. For example, the command may indicate a size of the portion of the volatile memory array 245 (e.g., or the non-volatile memory array 225) of the memory device 240 to reserve for storing the ephemeral data. In some cases, the command may indicate a desired minimum retention time of the ephemeral data. For example, the command may indicate a duration for which the ephemeral data may be stored in the portion of the volatile memory array 245 (e.g., or the non-volatile memory array 225). In other cases, the command may indicate a desired maximum latency for accessing the ephemeral data (e.g., based on the retention time). For example, the host system 205 may transmit the command may indicating a desired maximum latency for accessing the ephemeral data stored in the portion of the volatile memory array 245 (e.g., or the non-volatile memory array 225), and the memory system controller 215 may determine the highest retention time of the ephemeral data for offering the desired maximum latency. For example, the memory system controller 215 may determine that at a maximum latency value of X nanoseconds, a portion allocated for the storage of ephemeral data may be capable of offering a retention time of Y nanoseconds for storing the ephemeral data in the portion. The memory system controller 215 may transmit an indication of the retention time to the host system 205 in response to receiving the command indicating the desired maximum latency. In some cases, the command may indicate a size of the portion, a desired minimum retention time of the ephemeral data, a desired maximum latency for accessing the ephemeral data, or a combination thereof.

In some cases, in response to receiving the command, the memory system controller 215 may determine whether a portion of the volatile memory array 245 (e.g., or the non-volatile memory array 225) exists that is capable of satisfying the parameters indicated in the command. In some examples, the memory system controller 215 may determine the volatile memory array 245 (e.g., or the non-volatile memory array 225) does not include a portion that is capable of satisfying the parameters indicated in the command, and the memory system controller 215 may indicate to the host system 205 that the memory system 210 may not support executing the command. In other examples, the memory system controller 215 may determine the volatile memory array 245 (e.g., or the non-volatile memory array 225) does include a portion that is capable of satisfying the parameters indicated in the command, and the process flow 300 may continue to step 310.

At 310, the memory system controller 215 may allocate the portion of the memory device 240 (e.g., or the memory device 220) for storing the ephemeral data in accordance with the command received from the host system 205 (e.g., at step 305). For example, the memory system controller 215 may allocate a portion of the volatile memory array 245 (e.g., or the non-volatile memory array 225) to serve as ephemeral data storage 246 (e.g., or the ephemeral data storage 247).

At 315, the host system 205 may transmit a command to the memory system controller 215 indicating the memory system 210 to enter a performance mode (e.g., a high performance mode). In some cases, the memory system controller 215 may transmit the command to the memory device 240 (e.g., or the memory device 220), indicating the memory device 240 to enter the performance mode. In other cases, the memory system controller 215 may configure the memory device 240 for the performance mode based on receiving the command. In some examples, the command may indicate the memory device 240 to suspend memory management operations.

At 320, the memory device 240 (e.g., or the memory device 220) may enter the performance mode. In some cases, entering the performance mode may include suspending memory management operations of the portion of the memory device 240 allocated for storing the ephemeral data. For example, the memory device 240 may refrain from performing refresh operations on the portion, may decrease a frequency for performing error detection operations on the portion, may refrain from performing error correction operations on the portion, or a combination thereof. In some examples, the memory device 240 may decrease the frequency to a frequency indicated by a command from the host system 205 (e.g., the command received at step 315 or another command). In some cases, suspending the memory management operations may conserve a bandwidth of the memory system controller 215.

At 325, the ephemeral data may be transferred to the memory device 240 (e.g., or the memory device 22). In some cases, the ephemeral data may be transmitted from the host system 205, such that the ephemeral data may be receive from the host system 205 and written directly to the memory device 240 (e.g., via the memory system controller 215). In other cases, the ephemeral data may be transferred from the memory device 220 to the memory device 240 (e.g., via the memory system controller 215). In some examples, prior to transferring the ephemeral data, the ephemeral data may be identified from the memory device 220. In some cases, the ephemeral data may be transferred from another portion of the memory device 240 to the portion of the memory device 240 allocated for storing the ephemeral data.

At 330, the ephemeral data may be stored to the memory device 240 (e.g., or the memory device 220). The ephemeral data may be stored to the portion of the memory device 240 allocated for storing the ephemeral data (e.g., at step 310).

At 335, the memory device 240 (e.g., or the memory device 220) may perform an error detection operation. In some cases, performing the error detection operation may include receiving a command to perform the error detection operation or a frequency for performing the error detection operation. The error detection operation may include performing a one-time error check, or a periodic error check, to determine a quantity of errors in the ephemeral data. In some examples, the memory device 240 may determine a quantity of no errors in the ephemeral data, or the quantity of errors in the ephemeral data does not satisfy a threshold (e.g., a threshold of errors, based on a quantity of allowable errors in the ephemeral data) and the memory device 240 may continue normal operation (e.g., refrain from performing steps 340 through 355). However, in other examples, the memory device 240 may determine the quantity of errors in the ephemeral data satisfies a threshold. In some examples, the error detection operation may be preceded by a special operating code (e.g., an ephemeral load code) dictating that after detecting one or more errors, the memory device 240 may continue normal operations rather than suspending normal operations to correct or transmit an indication of the one or more errors. In some such examples, after detecting the one or more errors, the special operating code may dictate the memory device 240 to perform corrective processes for the one or more errors in the background operation of the memory device 240 (e.g., with a low priority for error correction).

At 340, the host system 205 may receive an indication of the quantity of errors in the ephemeral data from the memory device 240 (e.g., or the memory device 240). In some cases, receiving the indication may include receiving a system interrupt including addresses of the memory device 240 associated with the quantity of errors. In other cases, receiving the indication may include querying the memory device 240 for the addresses, identifying processes associated with the addresses, and suspending the processes (e.g., via interrupt signaling). In some cases, the host system 205 may check a queue (e.g., a user-mode message queue) shared between the memory system 210 and the host system 205 to determine the quantity of errors detected at the memory device 240. For example, the memory device 240 may send a message to the queue indicating the quantity of errors after performing the error check, and the host system 205 may check the queue periodically for messages. In some cases, values (e.g., corresponding to addresses of the memory device 240) of a register associated with the memory device 240 may be updated to reflect the quantity of errors. In some such examples, the host system 205 may receive the indication based on checking the register to determine if a quantity of values of the register indicating the quantity of errors. In some implementations, the quantity of values of the register may trigger predicated instructions to perform error correction of the quantity of errors.

In some cases, the host system 205 may determine the quantity of errors does not satisfy a threshold and the host system 205 may instruct the memory device 240 (e.g., or the memory device 220) to operate normally (e.g., return the process flow to step 335). For example, the host system 205 may have a weighting system that dictates an allowable quantity of errors in the ephemeral data such that if the quantity of errors in the ephemeral data is within the allowable quantity of errors, the quantity of errors may be ignored. However, in other cases, the host system 205 may determine the quantity of errors satisfies a threshold and the host system 205 initiate transferring second ephemeral data to the memory device 240.

At 345, second ephemeral data may be transferred to the memory device 240 (e.g., or the memory device 220). The second ephemeral data may be back-up data for the ephemeral data. In some cases, the second ephemeral data may be transmitted from the host system 205, such that the second ephemeral data may be received from the host system 205 and written directly to the memory device 240 (e.g., via the memory system controller 215). In other cases, the second ephemeral data may be transferred from the memory device 220 to the memory device 240 (e.g., via the memory system controller 215). In some examples, prior to transferring the second ephemeral data, the second ephemeral data may be identified from the memory device 220. In other cases, the second ephemeral data may be transferred from another portion of the memory device 240 to the portion of the memory device 240 allocated for storing the ephemeral data.

At 350, the second ephemeral data may be generated and transferred to the memory device 240 (e.g., or the memory device 220). In some cases, rather than transferring the second ephemeral data to the memory device 240, the second ephemeral data may be generated (e.g., recomputed) based on the ephemeral data stored in the memory device. In some such cases, the second ephemeral data may be generated by the host system 205, the memory system controller 215, or a local controller 241 (e.g., an embedded processor) of the memory device 240. After generating the second ephemeral data, the second ephemeral data may be transferred to the memory device 240.

At 355, the second ephemeral data may be stored to the memory device 240 (e.g., or the memory device 220). The second ephemeral data may be stored to the portion of the memory device 240 allocated for storing the ephemeral data (e.g., at step 310). In some cases, storing the second ephemeral data to the portion of the memory device 240 may include replacing (e.g., erasing and overwriting) the ephemeral data stored in the portion of the memory device 240 with the second ephemeral data. In some examples, only the ephemeral data associated with one or more errors may be replaced by the second ephemeral data. However, in other examples, all the ephemeral data in the portion of the memory device 240 may be replaced by the second ephemeral data.

In accordance with examples as described herein, storing ephemeral data in the memory device 240 (e.g., or the memory device 220) may enable the memory device 240 to be operated according to a performance mode associating with reducing latency of the memory system 210. Reducing latency of the memory system may improve performance of the memory system 210 and the host system 205.

FIG. 4 shows a block diagram 400 of a memory system 420 that supports management and control for ephemeral data in accordance with examples as disclosed herein. The memory system 420 may be an example of aspects of a memory system as described with reference to FIGS. 1 through 3. The memory system 420, or various components thereof, may be an example of means for performing various aspects of management and control for ephemeral data as described herein. For example, the memory system 420 may include an allocation component 425, a performance component 430, a storing component 435, an error control component 440, a transmission component 445, a reception component 450, a transferring component 455, an update component 460, a generation component 465, or any combination thereof. Each of these components may communicate, directly or indirectly, with one another (e.g., via one or more buses).

The allocation component 425 may be configured as or otherwise support a means for allocating a portion of a memory device of a memory system for storing ephemeral data that has a first retention parameter that is smaller than a second retention parameter associated with other data stored by the memory system. The performance component 430 may be configured as or otherwise support a means for suspending one or more memory management operations for the portion of the memory device based on allocating the portion for storing the ephemeral data. The storing component 435 may be configured as or otherwise support a means for storing the ephemeral data to the portion of the memory device based on suspending the one or more memory management operations. The error control component 440 may be configured as or otherwise support a means for performing, by the memory system, an error control procedure to identify an error in the ephemeral data based on performing an error detection operation on the ephemeral data. The transmission component 445 may be configured as or otherwise support a means for transmitting, by the memory system, an indication of the error based on performing the error control procedure.

In some examples, the reception component 450 may be configured as or otherwise support a means for receiving a command to allocate the portion of the memory device, where allocating the portion of the memory device is based on receiving the command.

In some examples, the command indicates a size of the portion of the memory device to allocate, a minimum retention time for the ephemeral data stored in the portion of the memory device, a latency associated with accessing the ephemeral data in the memory device, or a combination thereof.

In some examples, the transferring component 455 may be configured as or otherwise support a means for transferring the ephemeral data from a second portion of the memory device to the portion of the memory device or a second memory device of the memory system, where storing the ephemeral data to the portion of the memory device is based at least on transferring the ephemeral data.

In some examples, the reception component 450 may be configured as or otherwise support a means for receiving the ephemeral data from a host system coupled with the memory system. In some examples, the storing component 435 may be configured as or otherwise support a means for writing the ephemeral data to the portion of the memory device, where storing the ephemeral data is based on the writing.

In some examples, the reception component 450 may be configured as or otherwise support a means for receiving an indication to perform the error detection operation or an indication of a frequency for performing the error detection operation, where performing the error detection operation is based on receiving the indication.

In some examples, the storing component 435 may be configured as or otherwise support a means for storing second ephemeral data to the portion of the memory device based on transmitting the indication, the second ephemeral data including back-up data for the ephemeral data.

In some examples, the generation component 465 may be configured as or otherwise support a means for generating, by a processor of the memory system, the second ephemeral data, where storing the second ephemeral data is based on generating the second ephemeral data.

In some examples, the performance component 430 may be configured as or otherwise support a means for entering a performance mode associated with operating the portion of the memory device based on allocating the portion of the memory device, where suspending the one or more memory management operations is based on entering the performance mode.

In some examples, to support suspending the one or more memory management operations, the performance component 430 may be configured as or otherwise support a means for refraining from performing refresh operations on the ephemeral data in the portion of the memory device, decreasing a frequency for performing the error detection operation, refraining from performing an error correction operation on the ephemeral data in the portion of the memory device, or any combination thereof.

In some examples, the update component 460 may be configured as or otherwise support a means for updating a value of a register associated with the portion of the memory device, the value corresponding to an address associated with the error in the ephemeral data.

In some examples, the indication includes an interrupt with a list of addresses associated with errors in the ephemeral data.

In some examples, the indication includes a message transmitted to a queue between the memory system and a host system coupled with the memory system.

In some examples, the indication includes an operating code associated with storing the ephemeral data.

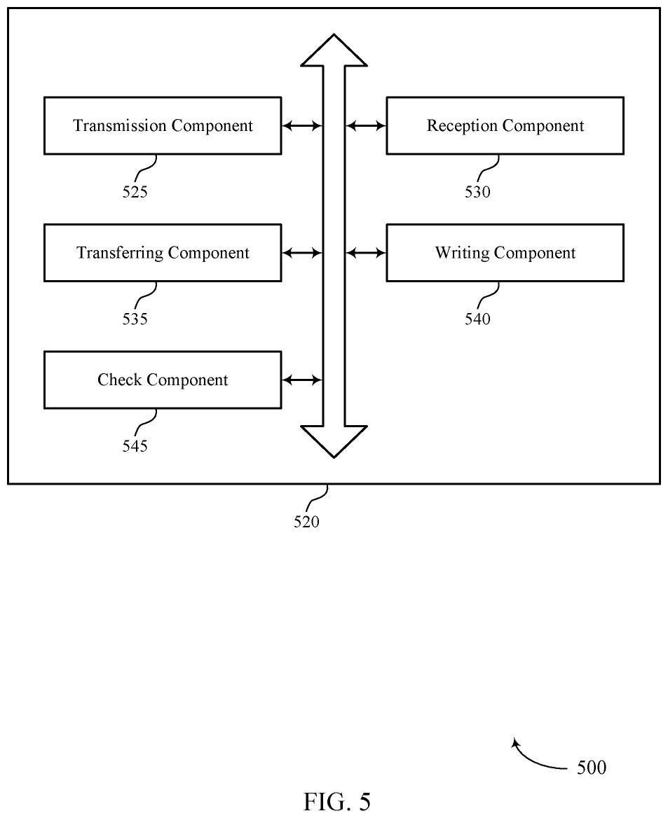

FIG. 5 shows a block diagram 500 of a host system 520 that supports management and control for ephemeral data in accordance with examples as disclosed herein. The host system 520 may be an example of aspects of a host system as described with reference to FIGS. 1 through 3. The host system 520, or various components thereof, may be an example of means for performing various aspects of management and control for ephemeral data as described herein. For example, the host system 520 may include a transmission component 525, a reception component 530, a transferring component 535, a writing component 540, a check component 545, or any combination thereof. Each of these components may communicate, directly or indirectly, with one another (e.g., via one or more buses).

The transmission component 525 may be configured as or otherwise support a means for transmitting a command to allocate a portion of a memory device for storing ephemeral data that has a first retention parameter that is smaller than a second retention parameter associated with other data stored by the memory system. In some examples, the transmission component 525 may be configured as or otherwise support a means for transmitting ephemeral data to the portion of the memory device based on transmitting the command. The reception component 530 may be configured as or otherwise support a means for receiving an indication of an error in the ephemeral data. In some examples, the transmission component 525 may be configured as or otherwise support a means for transmitting second ephemeral data to the portion of the memory device based on receiving the indication of the error, the second ephemeral data including back-up data for the ephemeral data.

In some examples, the command indicates a size of the portion of the memory device to allocate, a desired minimum retention time for the ephemeral data stored in the portion of the memory device, or a desired latency associated with accessing the ephemeral data in the memory device.

In some examples, to support transmitting the ephemeral data to the portion of the memory device, the transferring component 535 may be configured as or otherwise support a means for transferring the ephemeral data from a second memory device or a second portion of the memory device to the portion of the memory device.

In some examples, to support transmitting the ephemeral data to the portion of the memory device, the writing component 540 may be configured as or otherwise support a means for writing the ephemeral data to the portion of the memory device.

In some examples, to support transmitting the second ephemeral data to the portion of the memory device, the transferring component 535 may be configured as or otherwise support a means for transferring the second ephemeral data from a second memory device or a second portion of the memory device to the portion of the memory device.

In some examples, the transmission component 525 may be configured as or otherwise support a means for transmitting a second indication to perform an error detection operation or a frequency for performing the error detection operation, where receiving the indication is based on transmitting the second indication.

In some examples, to support receiving the indication, the check component 545 may be configured as or otherwise support a means for checking a register associated with the portion of the memory device for a bit corresponding to an address associated with the error in the ephemeral data.

In some examples, the indication includes an interrupt with a list of addresses associated with errors in the ephemeral data, a message received from a queue, or an operating code associated with storing the ephemeral data.

In some examples, the transmission component 525 may be configured as or otherwise support a means for transmitting a second indication to suspend one or more memory management operations for the portion of the memory device based on transmitting the command, where transmitting the ephemeral data is based on transmitting the second indication.

In some examples, to support transmitting the second indication to suspend the one or more memory management operations, the transmission component 525 may be configured as or otherwise support a means for transmitting a second command indicating the memory device to enter a performance mode associated with operating the portion of the memory device.

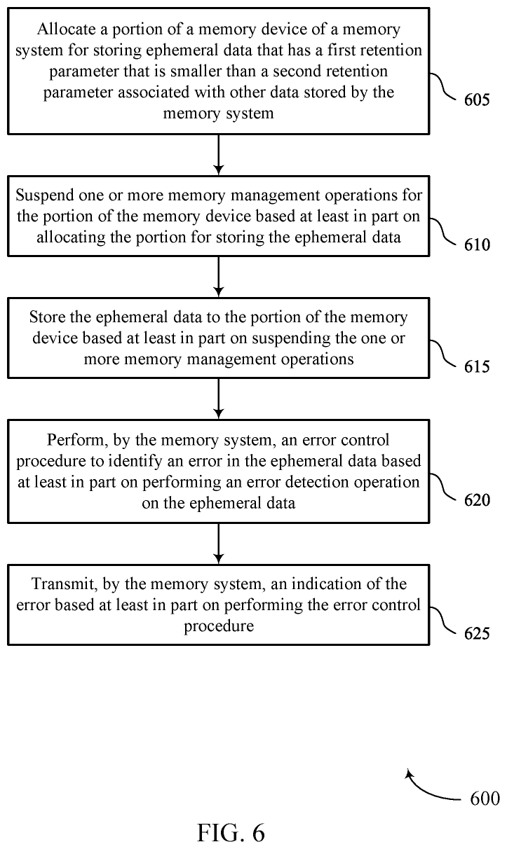

FIG. 6 shows a flowchart illustrating a method 600 that supports management and control for ephemeral data in accordance with examples as disclosed herein. The operations of method 600 may be implemented by a memory system or its components as described herein. For example, the operations of method 600 may be performed by a memory system as described with reference to FIGS. 1 through 4. In some examples, a memory system may execute a set of instructions to control the functional elements of the device to perform the described functions. Additionally, or alternatively, the wireless memory system may perform aspects of the described functions using special-purpose hardware.

At 605, the method may include allocating a portion of a memory device of a memory system for storing ephemeral data that has a first retention parameter that is smaller than a second retention parameter associated with other data stored by the memory system. The operations of 605 may be performed in accordance with examples as disclosed herein. In some examples, aspects of the operations of 605 may be performed by an allocation component 425 as described with reference to FIG. 4. For example, a memory system controller 215 may be configured to allocate the portion of the memory device, as described with reference to FIG. 2.

At 610, the method may include suspending one or more memory management operations for the portion of the memory device based on allocating the portion for storing the ephemeral data. The operations of 610 may be performed in accordance with examples as disclosed herein. In some examples, aspects of the operations of 610 may be performed by a performance component 430 as described with reference to FIG. 4. For example, a host system controller 206 may be configured to suspend the one or more memory management operations for the portion of the memory device, as described with reference to FIG. 2.

At 615, the method may include storing the ephemeral data to the portion of the memory device based on suspending the one or more memory management operations. The operations of 615 may be performed in accordance with examples as disclosed herein. In some examples, aspects of the operations of 615 may be performed by a storing component 435 as described with reference to FIG. 4. For example, the memory system controller 215 may be configured to store the ephemeral data to the portion of the memory device.

At 620, the method may include performing, by the memory system, an error control procedure to identify an error in the ephemeral data based on performing an error detection operation on the ephemeral data. The operations of 620 may be performed in accordance with examples as disclosed herein. In some examples, aspects of the operations of 620 may be performed by an error control component 440 as described with reference to FIG. 4. For example, a local controller 241 may be configured to perform the error control procedure to identify the error in the ephemeral data, as described with reference to FIG. 2.

At 625, the method may include transmitting, by the memory system, an indication of the error based on performing the error control procedure. The operations of 625 may be performed in accordance with examples as disclosed herein. In some examples, aspects of the operations of 625 may be performed by a transmission component 445 as described with reference to FIG. 4. For example, the memory system controller 215 may be configured to transmit the indication of the error to a host system 205 coupled with the memory system controller, as described with reference to FIG. 2.

In some examples, an apparatus as described herein may perform a method or methods, such as the method 600. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for allocating a portion of a memory device of a memory system for storing ephemeral data that has a first retention parameter that is smaller than a second retention parameter associated with other data stored by the memory system; suspending one or more memory management operations for the portion of the memory device based on allocating the portion for storing the ephemeral data; storing the ephemeral data to the portion of the memory device based on suspending the one or more memory management operations; performing, by the memory system, an error control procedure to identify an error in the ephemeral data based on performing an error detection operation on the ephemeral data; and transmitting, by the memory system, an indication of the error based on performing the error control procedure.

Aspect 2: The method, apparatus, or non-transitory computer-readable medium of aspect 1, further including operations, features, circuitry, logic, means, or instructions, or any combination thereof for receiving a command to allocate the portion of the memory device, where allocating the portion of the memory device is based on receiving the command.

Aspect 3: The method, apparatus, or non-transitory computer-readable medium of aspect 2, where the command indicates a size of the portion of the memory device to allocate, a minimum retention time for the ephemeral data stored in the portion of the memory device, a latency associated with accessing the ephemeral data in the memory device, or a combination thereof.

Aspect 4: The method, apparatus, or non-transitory computer-readable medium of any of aspects 1 through 3, further including operations, features, circuitry, logic, means, or instructions, or any combination thereof for transferring the ephemeral data from a second portion of the memory device to the portion of the memory device or a second memory device of the memory system, where storing the ephemeral data to the portion of the memory device is based at least on transferring the ephemeral data.

Aspect 5: The method, apparatus, or non-transitory computer-readable medium of any of aspects 1 through 4, further including operations, features, circuitry, logic, means, or instructions, or any combination thereof for receiving the ephemeral data from a host system coupled with the memory system and writing the ephemeral data to the portion of the memory device, where storing the ephemeral data is based on the writing.

Aspect 6: The method, apparatus, or non-transitory computer-readable medium of any of aspects 1 through 5, further including operations, features, circuitry, logic, means, or instructions, or any combination thereof for receiving an indication to perform the error detection operation or an indication of a frequency for performing the error detection operation, where performing the error detection operation is based on receiving the indication.

Aspect 7: The method, apparatus, or non-transitory computer-readable medium of any of aspects 1 through 6, further including operations, features, circuitry, logic, means, or instructions, or any combination thereof for storing second ephemeral data to the portion of the memory device based on transmitting the indication, the second ephemeral data including back-up data for the ephemeral data.

Aspect 8: The method, apparatus, or non-transitory computer-readable medium of aspect 7, further including operations, features, circuitry, logic, means, or instructions, or any combination thereof for generating, by a processor of the memory system, the second ephemeral data, where storing the second ephemeral data is based on generating the second ephemeral data.

Aspect 9: The method, apparatus, or non-transitory computer-readable medium of any of aspects 1 through 8, further including operations, features, circuitry, logic, means, or instructions, or any combination thereof for entering a performance mode associated with operating the portion of the memory device based on allocating the portion of the memory device, where suspending the one or more memory management operations is based on entering the performance mode.

Aspect 10: The method, apparatus, or non-transitory computer-readable medium of any of aspects 1 through 9, where suspending the one or more memory management operations includes operations, features, circuitry, logic, means, or instructions, or any combination thereof for refraining from performing refresh operations on the ephemeral data in the portion of the memory device, decreasing a frequency for performing the error detection operation, refraining from performing an error correction operation on the ephemeral data in the portion of the memory device, or any combination thereof.

Aspect 11: The method, apparatus, or non-transitory computer-readable medium of any of aspects 1 through 10, further including operations, features, circuitry, logic, means, or instructions, or any combination thereof for updating a value of a register associated with the portion of the memory device, the value corresponding to an address associated with the error in the ephemeral data.

Aspect 12: The method, apparatus, or non-transitory computer-readable medium of any of aspects 1 through 11, where the indication includes an interrupt with a list of addresses associated with errors in the ephemeral data.

Aspect 13: The method, apparatus, or non-transitory computer-readable medium of any of aspects 1 through 12, where the indication includes a message transmitted to a queue between the memory system and a host system coupled with the memory system.

Aspect 14: The method, apparatus, or non-transitory computer-readable medium of any of aspects 1 through 13, where the indication includes an operating code associated with storing the ephemeral data.

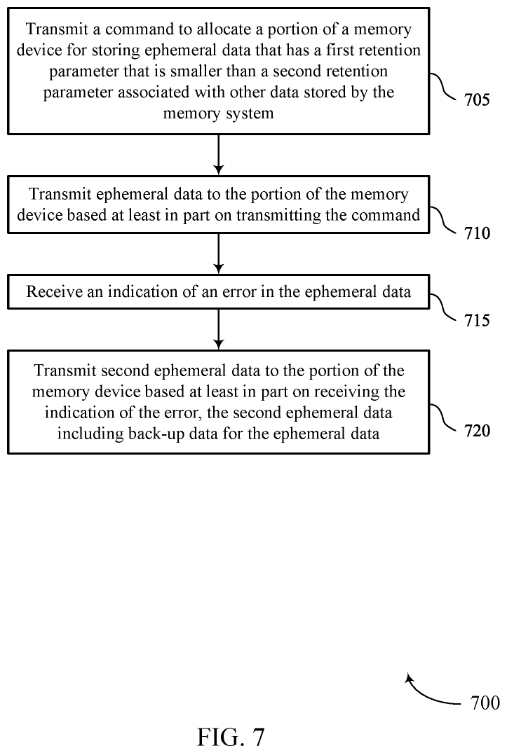

FIG. 7 shows a flowchart illustrating a method 700 that supports management and control for ephemeral data in accordance with examples as disclosed herein. The operations of method 700 may be implemented by a host system or its components as described herein. For example, the operations of method 700 may be performed by a host system as described with reference to FIGS. 1 through 3 and 5. In some examples, a host system may execute a set of instructions to control the functional elements of the device to perform the described functions. Additionally, or alternatively, the wireless host system may perform aspects of the described functions using special-purpose hardware.

At 705, the method may include transmitting a command to allocate a portion of a memory device for storing ephemeral data that has a first retention parameter that is smaller than a second retention parameter associated with other data stored by the memory system. The operations of 705 may be performed in accordance with examples as disclosed herein. In some examples, aspects of the operations of 705 may be performed by a transmission component 525 as described with reference to FIG. 5. For example, a host system controller 206 may be configured to transmit the command to allocate the portion of the memory device for storing the ephemeral data, as described with reference to FIG. 2.

At 710, the method may include transmitting ephemeral data to the portion of the memory device based on transmitting the command. The operations of 710 may be performed in accordance with examples as disclosed herein. In some examples, aspects of the operations of 710 may be performed by a transmission component 525 as described with reference to FIG. 5. For example, the host system controller 206 may be configured to transmit the ephemeral data to the portion of the memory device.

At 715, the method may include receiving an indication of an error in the ephemeral data. The operations of 715 may be performed in accordance with examples as disclosed herein. In some examples, aspects of the operations of 715 may be performed by a reception component 530 as described with reference to FIG. 5. For example, the host system controller 206 may be configured to receive the indication of the error in the ephemeral data.

At 720, the method may include transmitting second ephemeral data to the portion of the memory device based on receiving the indication of the error, the second ephemeral data including back-up data for the ephemeral data. The operations of 720 may be performed in accordance with examples as disclosed herein. In some examples, aspects of the operations of 720 may be performed by a transmission component 525 as described with reference to FIG. 5. For example, the host system controller 206 may be configured to transmit the second ephemeral data to the portion of the memory device.

In some examples, an apparatus as described herein may perform a method or methods, such as the method 700. The apparatus may include features, circuitry, logic, means, or instructions (e.g., a non-transitory computer-readable medium storing instructions executable by a processor), or any combination thereof for performing the following aspects of the present disclosure:

Aspect 15: A method, apparatus, or non-transitory computer-readable medium including operations, features, circuitry, logic, means, or instructions, or any combination thereof for transmitting a command to allocate a portion of a memory device for storing ephemeral data that has a first retention parameter that is smaller than a second retention parameter associated with other data stored by the memory system; transmitting ephemeral data to the portion of the memory device based on transmitting the command; receiving an indication of an error in the ephemeral data; and transmitting second ephemeral data to the portion of the memory device based on receiving the indication of the error, the second ephemeral data including back-up data for the ephemeral data.

Aspect 16: The method, apparatus, or non-transitory computer-readable medium of aspect 15, where the command indicates a size of the portion of the memory device to allocate, a desired minimum retention time for the ephemeral data stored in the portion of the memory device, or a desired latency associated with accessing the ephemeral data in the memory device.

Aspect 17: The method, apparatus, or non-transitory computer-readable medium of any of aspects 15 through 16, where transmitting the ephemeral data to the portion of the memory device includes operations, features, circuitry, logic, means, or instructions, or any combination thereof for transferring the ephemeral data from a second memory device or a second portion of the memory device to the portion of the memory device.

Aspect 18: The method, apparatus, or non-transitory computer-readable medium of any of aspects 15 through 17, where transmitting the ephemeral data to the portion of the memory device includes operations, features, circuitry, logic, means, or instructions, or any combination thereof for writing the ephemeral data to the portion of the memory device.

Aspect 19: The method, apparatus, or non-transitory computer-readable medium of any of aspects 15 through 18, where transmitting the second ephemeral data to the portion of the memory device includes operations, features, circuitry, logic, means, or instructions, or any combination thereof for transferring the second ephemeral data from a second memory device or a second portion of the memory device to the portion of the memory device.

Aspect 20: The method, apparatus, or non-transitory computer-readable medium of any of aspects 15 through 19, further including operations, features, circuitry, logic, means, or instructions, or any combination thereof for transmitting a second indication to perform an error detection operation or a frequency for performing the error detection operation, where receiving the indication is based on transmitting the second indication.

Aspect 21: The method, apparatus, or non-transitory computer-readable medium of any of aspects 15 through 20, where receiving the indication includes operations, features, circuitry, logic, means, or instructions, or any combination thereof for checking a register associated with the portion of the memory device for a bit corresponding to an address associated with the error in the ephemeral data.

Aspect 22: The method, apparatus, or non-transitory computer-readable medium of any of aspects 15 through 21, where the indication includes an interrupt with a list of addresses associated with errors in the ephemeral data, a message received from a queue, or an operating code associated with storing the ephemeral data.

Aspect 23: The method, apparatus, or non-transitory computer-readable medium of any of aspects 15 through 22, further including operations, features, circuitry, logic, means, or instructions, or any combination thereof for transmitting a second indication to suspend one or more memory management operations for the portion of the memory device based on transmitting the command, where transmitting the ephemeral data is based on transmitting the second indication.

Aspect 24: The method, apparatus, or non-transitory computer-readable medium of aspect 23, where transmitting the second indication to suspend the one or more memory management operations includes operations, features, circuitry, logic, means, or instructions, or any combination thereof for transmitting a second command indicating the memory device to enter a performance mode associated with operating the portion of the memory device.

It should be noted that the methods described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. At any given time, a conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to condition of moving from an open-circuit relationship between components in which signals are not presently capable of being communicated between the components (e.g., over a conductive path) to a closed-circuit relationship between components in which signals are capable of being communicated between components (e.g., over the conductive path). When a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other when the switch is open. When a controller isolates two components, the controller affects a change that prevents signals from flowing between the components using a conductive path that previously permitted signals to flow.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component (e.g., a transistor) discussed herein may represent a field-effect transistor (FET), and may comprise a three-terminal component including a source (e.g., a source terminal), a drain (e.g., a drain terminal), and a gate (e.g., a gate terminal). The terminals may be connected to other electronic components through conductive materials (e.g., metals, alloys). The source and drain may be conductive, and may comprise a doped (e.g., heavily doped, degenerate) semiconductor region. The source and drain may be separated by a doped (e.g., lightly doped) semiconductor region or channel. If the channel is n-type (e.g., majority carriers are electrons), then the FET may be referred to as a n-type FET. If the channel is p-type (e.g., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” when a voltage greater than or equal to the transistor's threshold voltage is applied to the transistor gate. The transistor may be “off” or “deactivated” when a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

The functions described herein may be implemented in hardware, software executed by a processor, firmware, or any combination thereof. If implemented in software executed by a processor, the functions may be stored on or transmitted over as one or more instructions (e.g., code) on a computer-readable medium. Other examples and implementations are within the scope of the disclosure and appended claims. For example, due to the nature of software, functions described herein can be implemented using software executed by a processor, hardware, firmware, hardwiring, or combinations of any of these. Features implementing functions may also be physically located at various positions, including being distributed such that portions of functions are implemented at different physical locations.

For example, the various illustrative blocks and modules described in connection with the disclosure herein may be implemented or performed with a processor, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or any type of processor. A processor may also be implemented as a combination of computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based on.”

Computer-readable media includes both non-transitory computer storage media and communication media including any medium that facilitates transfer of a computer program from one place to another. A non-transitory storage medium may be any available medium that can be accessed by a computer. By way of example, and not limitation, non-transitory computer-readable media can comprise RAM, ROM, electrically erasable programmable read-only memory (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a computer, or a processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, digital subscriber line (DSL), or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method, comprising:
allocating a portion of a memory device of a memory system for storing ephemeral data that has a first retention parameter that is smaller than a second retention parameter associated with other data stored by the memory system;
suspending one or more memory management operations for the portion of the memory device based on allocating the portion for storing the ephemeral data;
storing the ephemeral data to the portion of the memory device based on suspending the one or more memory management operations;
performing, by the memory system, an error control procedure to identify an error in the ephemeral data based on performing an error detection operation on the ephemeral data; and
transmitting, by the memory system, an indication of the error based on performing the error control procedure.

2. The method of claim 1, further comprising:
receiving a command to allocate the portion of the memory device, wherein allocating the portion of the memory device is based on receiving the command, and wherein the command indicates a size of the portion of the memory device to allocate, a minimum retention time for the ephemeral data stored in the portion of the memory device, a latency associated with accessing the ephemeral data in the memory device, or a combination thereof.

3. The method of claim 1, further comprising:
transferring the ephemeral data from a second portion of the memory device to the portion of the memory device or a second memory device of the memory system, wherein storing the ephemeral data to the portion of the memory device is based at least on transferring the ephemeral data.

4. The method of claim 1, further comprising:
receiving the ephemeral data from a host system coupled with the memory system; and
writing the ephemeral data to the portion of the memory device, wherein storing the ephemeral data is based on the writing.

5. The method of claim 1, further comprising:
receiving an indication to perform the error detection operation or an indication of a frequency for performing the error detection operation, wherein performing the error detection operation is based on receiving the indication.

6. The method of claim 1, further comprising:
storing second ephemeral data to the portion of the memory device based on transmitting the indication, the second ephemeral data comprising back-up data for the ephemeral data.

7. The method of claim 6, further comprising:
generating, by a processor of the memory system, the second ephemeral data, wherein storing the second ephemeral data is based on generating the second ephemeral data.

8. The method of claim 1, further comprising:
entering a performance mode associated with operating the portion of the memory device based on allocating the portion of the memory device, wherein suspending the one or more memory management operations is based on entering the performance mode.

9. The method of claim 1, wherein suspending the one or more memory management operations comprises:
refraining from performing refresh operations on the ephemeral data in the portion of the memory device, decreasing a frequency for performing the error detection operation, refraining from performing an error correction operation on the ephemeral data in the portion of the memory device, or any combination thereof.

10. The method of claim 1, further comprising:
updating a value of a register associated with the portion of the memory device, the value corresponding to an address associated with the error in the ephemeral data.

11. The method of claim 1, wherein the indication comprises an interrupt with a list of addresses associated with errors in the ephemeral data, a message transmitted to a queue between the memory system and a host system coupled with the memory system, or an operating code associated with storing the ephemeral data.

12. A method, comprising:
transmitting a command to allocate a portion of a memory device for storing ephemeral data that has a first retention parameter that is smaller than a second retention parameter associated with other data stored by the memory device;
transmitting the ephemeral data to the portion of the memory device based on transmitting the command;
receiving an indication of an error in the ephemeral data; and
transmitting second ephemeral data to the portion of the memory device based on receiving the indication of the error, the second ephemeral data comprising back-up data for the ephemeral data.

13. The method of claim 12, wherein the command indicates a size of the portion of the memory device to allocate, a desired minimum retention time for the ephemeral data stored in the portion of the memory device, or a desired latency associated with accessing the ephemeral data in the memory device.

14. The method of claim 12, wherein transmitting the ephemeral data or the second ephemeral data to the portion of the memory device comprises:
transferring the ephemeral data or the second ephemeral data from a second memory device or a second portion of the memory device to the portion of the memory device.

15. The method of claim 12, further comprising:
transmitting a second indication to perform an error detection operation or a frequency for performing the error detection operation, wherein receiving the indication is based on transmitting the second indication.

16. The method of claim 12, wherein receiving the indication comprises:
checking a register associated with the portion of the memory device for a bit corresponding to an address associated with the error in the ephemeral data.

17. The method of claim 12, wherein the indication comprises an interrupt with a list of addresses associated with errors in the ephemeral data, a message received from a queue, or an operating code associated with storing the ephemeral data.

18. The method of claim 12, further comprising:
transmitting a second indication to suspend one or more memory management operations for the portion of the memory device based on transmitting the command, wherein transmitting the ephemeral data is based on transmitting the second indication.

19. The method of claim 18, wherein transmitting the second indication to suspend the one or more memory management operations comprises:
transmitting a second command indicating the memory device to enter a performance mode associated with operating the portion of the memory device.

20. An apparatus, comprising:
one or more memory devices; and
one or more controllers coupled with the one or more memory devices and configured to cause the apparatus to:
allocate a portion of the one or more memory devices for storing ephemeral data that has a first retention parameter that is smaller than a second retention parameter associated with other data stored by the one or more memory devices;
suspend one or more memory management operations for the portion of the one or more memory devices based on allocating the portion for storing the ephemeral data;
store the ephemeral data to the portion of the one or more memory devices based on suspending the one or more memory management operations;
perform an error control procedure to identify an error in the ephemeral data based on performing an error detection operation on the ephemeral data; and
transmit an indication of the error based on performing the error control procedure.
